(19) United States
(12) Patent Application Publication
(10) Pub. No.: US 2007/0061608 A1
(43) Pub. Date: Mar. 15, 2007

(54) Method and apparatus for a time domain probabilistic risk assessment model, analysis of interaction of disparate networks, and a repair simulation tool

(75) Inventors: George H. Baker, Harrisonburg, VA (US); Philip B. Riley, Harrisonburg, VA (US); Samuel T. Redwine JR., Harrisonburg, VA (US); James P. McManus, Appleton, WI (US)

Correspondence Address: FOLEY AND LARDNER LLP;SUITE 500, 3000 K STREET NW, WASHINGTON, DC, 20007, US

(73) Assignee: James Madison University

(21) Appl. No.: 11/518,881

(22) Filed: Sep. 12, 2006

Related U.S. Application Data
(60) Provisional application No. 60/717,581, filed on Sep. 15, 2005.
(60) Provisional application No. 60/799,338, filed on May 11, 2006.

(51) Int. Cl. G06F 11/00

(52) U.S. Cl. 714/1

(57) ABSTRACT

A risk assessment system includes a plurality of elements each having an attribute for determining if an event causes the respective element to fail. The risk assessment system also includes a repair component configured to repair each of the plurality of elements that has failed. The risk assessment system further includes an event generation component configured to generate an event to effect repair of the plurality of elements that have failed. The repair component performs a particular repair of each of the failed elements based on the event generated by the event generation component.

### RELATED APPLICATIONS

This application claims priority to U.S. provisional patent application Ser. Nos. 60/717,581, filed Sep. 15, 2005, and 60/799,338, filed May 11, 2006, both of which are incorporated herein by reference in their entirety.

### BACKGROUND OF THE INVENTION

Probabilistic risk assessments (PRAs) are known within the risk assessment community. A PRA is defined as a systematic and comprehensive methodology to evaluate risks associated with a complex engineered technological entity. PRAs are generally in the form of time independent analyses, such as fault tree analyses (FTAs) and event tree analyses (ETAs).

In FTAs, elements representing various faults are connected through logic gates (AND gates, OR gates, etc.) and assigned a probability of failure. In ETAs, elements represent various failure events that logically branch into effects caused by those failures. Due to the unique combination of events and logic, a failure probability can be determined for that particular configuration. However, these techniques fail when system complexity is increased beyond a certain threshold, when common cause failures occur, or when probabilities of failure rely on variables that are intrinsically time dependent.

Other risk assessment techniques, that may or may not be probabilistic, include such analyses as Failure Mode and Effect Analyses (FMEAs) and Failure Mode, Effect and Criticality Analyses (FMECAs.) These analyses techniques use detailed information about the various parts of a system to determine what can fail, how it can fail, and the effect on the overall system when the various parts fail in particular fashions. Sometimes these analyses will include probability of failure as one of the attributes of the analysis. However, these analyses only occasionally take time variables into account, and when they do so, only in the most rudimentary fashion. The main purpose of an FMEA or FMECA is to ensure that each possible failure mode is discovered and analyzed. Determining failure probabilities with FMEAs or FMECAs can be performed, however the analysis is inefficient. More usually, FMEA or FMECA analyses are used to develop fault trees that are used to determine probability of failure.

A further type of failure analysis is a Functional Hazard Analysis (FHA.) This analysis is a top down analysis that develops the generic functions that a system performs, and then delineates the system failures that could cause those functions to fail. This type of analysis is not probabilistic in nature nor is the analysis performed in the time domain.

Recovery simulation is generally abstracted from historic event records. Techniques include using ‘mean time to recover’ (MTTR) data from maintenance records, synthesizing recovery times based on surveys, and other techniques designed to determine the recovery time based on past performance. These techniques are generally useful for situations where repairs are conducted as part of general maintenance schemes or where there are no unusual situations that could affect the repair times. These techniques do not provide good results in situations where unforeseen events affect the repair operation, in situations where the base assumptions on which the data is collected are not valid, nor in situations that have not occurred in the past.

The nuclear power industry has used a technique wherein they add recover and probability of recovery events to fault trees to simulate repair actions and those event's affect on the operation of the system. They also have used a technique wherein they use a rules based heuristic to allow for the deletion of parts of the fault tree or certain cut sets. While these techniques provide an improvement on assuming a straight MTTR recovery analysis approach, it is still based on historic data and operator action based on known past events. The nuclear power industry also uses a time series Monte Carlo simulation approach to determining recovery (or non-recovery) times for certain conditions. This simulation compares non-probabilistic recovery times to mission completion times to determine if the repair impacts the total time to recovery. The shortfalls of this approach are that it requires historic recovery time benchmarks as well as not being truly conducted in the time domain.

### SUMMARY OF THE INVENTION

According to one aspect of the invention, there is provided a risk assessment system, which includes a plurality of elements each having an attribute for determining if an event causes the respective element to fail. The risk assessment system also includes a repair component configured to repair each of the plurality of elements that has failed. The risk assessment system further includes an event generation component configured to generate an event to effect repair of the plurality of elements that have failed. The repair component performs a particular repair of each of the failed elements based on the event generated by the event generation component.

According to another aspect of the invention, there is provided a risk assessment method for performing risk assessment on a system. The method includes assigning an attribute to a plurality of elements, for determining if an event causes the respective element to fail. The method also includes determining whether or not the event has occurred in the system, and which of the plurality of elements has failed. The method further includes repairing, by a repair component, each of the plurality of elements that has failed. The repairing step includes generating a particular event to effect repair of the plurality of elements that have failed.

According to yet another aspect of the invention, there is provided a computer program product executable on a general purpose computer, the computer program product being stored in a computer readable medium, and, when executed on the general purpose computer, causing the general purpose computer to perform steps of assigning an attribute to a plurality of elements, for determining if an event causes the respective element to fail; determining whether or not the event has occurred in the system, and which of the plurality of elements has failed; repairing, by a repair component, each of the plurality of elements that has failed, wherein the repairing step includes generating a particular event to effect repair of the plurality of elements that have failed.

### BRIEF DESCRIPTION OF THE DRAWINGS

FIG. 1 shows the class hierarchy of a Failure and Repair feature according to an embodiment of the invention.

FIG. 2 shows an example of event-object interaction according to an embodiment of the invention.

FIG. 3 shows an example of event-object interaction according to an embodiment of the invention.

FIG. 4 illustrates an exemplary process flow when a Repair Trigger event acts on a RepairManager element to indicate a failed Element, according to an embodiment of the invention.

FIG. 5 is a diagram that illustrates the Flow object according to an embodiment of the invention.

FIG. 6 is a diagram showing a repair agent that has constructed a transient connection between elements for them to traverse a network, according to an embodiment of the invention.

FIG. 7 is a diagram showing event handling according to an embodiment of the invention.

FIG. 8 is a diagram showing an event-driven scheduler process sequence according to an embodiment of the invention.

### DETAILED DESCRIPTION OF THE INVENTION

The present invention generally relates to risk assessment tools used in risk modeling. More particularly, the present invention relates to introducing time domain aspects into the analysis of probabilistic risk assessments, and the treatment of highly complex relationships, including the interaction of disparate network types, and the interaction of repair simulation activities, in software tools for performing a time domain probabilistic risk assessment.

Highly complex models typically are analyzed by separating the simulation into several parts that are generally considered to be independent. Further, typical risk analyses rely on the assumption that the systems under analysis are determinant, that is, that a single perturbation to the system results in a particular effect on that system, independent of other variables, including time. This analysis method is flawed in that many highly complex systems cannot be considered independently if the analysis is to produce realistic results.

Time is often the variable of interest in determining system failure and reconstitution effects. Typical risk analyses, including techniques such as fault tree analyses, common cause analyses, zonal analyses and failure modes and effects analyses do not take time into account as discussed earlier. Often, this deficit must be overcome by the user by performing the analyses several times to account for time domain variation. While this approach may yield rough estimates of event differences based on time variation, in many cases this is insufficient to produce results with the requisite accuracy.

A further problem with typical system analysis techniques is that many complex systems are not determinant. Several variables and levels of variables must be considered simultaneously before an accurate determination of the effect of a single variable change can be performed. Current analysis techniques often require a system model to be simplified into a determinant configuration before analysis can proceed, often through the use of cut sets or other techniques that simplify the analysis to the point that it can be mathematically analyzed.

Furthermore, when highly complex systems fail in unusual or unexpected manners, pre-existing algorithms or processes for determining repair times can fail to accurately analyze repair times required to reconstitute a complex system to an operational state. Typical repair algorithms rely on historically derived means, such as mean time before failure (MTBF) and mean time to repair (MTTR) lists to determine repair times. However, these figures produce flawed results when the scope of the repair falls outside the bounds of the environment in which the time figures were collected. Many serious emergency situations where repair assets are outside those bounds need to be analyzed. In many cases, repair and reconstitution times will be the most important outcomes of such analyses.

The following detailed description of embodiments of the present system refers to the accompanying drawings that illustrate exemplary embodiments. Other inventions are possible, and modifications may be made to the embodiments within the spirit and scope of the invention.

The present system may be implemented in many different embodiments of hardware, software, firmware, and/or the entities illustrated in the figures. Any actual software code with specialized, controlled hardware to implement the present system is not intended to limit the scope of the present invention which includes all alternatives, variations, and modifications that would be known to those skilled in the art. The operation and behavior of the present system will be described with the understanding that all such modifications and variations of the embodiments would be recognized by those skilled in the art.

Repair Capabilities:

In certain embodiments of the present system, the architecture of the Repair feature depends heavily on the Event architecture. A failure is indicated by a special attribute of an element, but the attribute is set as a result of an event. The modeler may specify a time event or a condition event to set the failure attribute.

After a failure occurs, the repair is also controlled by events. Whether the element self-repairs or a repair agent is required, an event (or events) must be generated to effect the repair.

In certain embodiments, the repair agent is an Element that is not visible in the model. The repair agent can be flowed through ports (which allow input/output to elements) to the failed Element or to follow diagnosis trees to other elements.

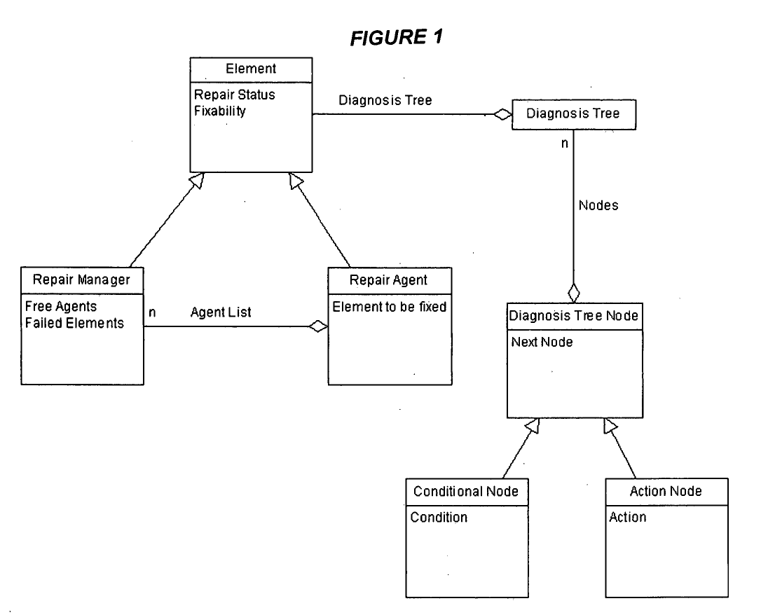

As shown in FIG. 1, which shows the class hierarchy of a Failure and Repair feature of a risk assessment system according to a first embodiment, that feature includes objects with run-time construction hierarchy (not necessarily the class hierarchy/inheritance) as follows, where Indented sub-items indicate parent-child relationships and a plural sub-item indicates a ‘one-to-many’ relationship with the parent container:
Model
Repair manager
   Repair agents
Diagnosis (Decision) Tree
   Diagnosis Tree Nodes (Action Nodes and/or Conditional Nodes)
      Failure/Repair Concept Diagrams

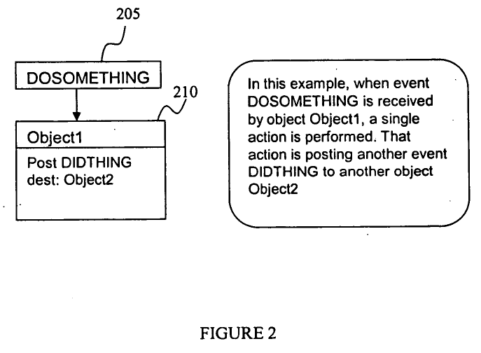

These processes are driven by events. The processes are represented by a collection of the events, their destination objects and the resulting actions taken by the destination object. Therefore, an event (or an event caused by a trigger) received by a particular object causes that object to perform some action(s). An example of event-object interaction in a risk assessment system of the first embodiment is shown in FIG. 2. As shown in FIG. 2, an event 205 (“DOSOMETHING”) is received by the object 210 (‘Object1”) which performs a single action which posts another event “DIDTHING” to another object Object2. Events that are essentially commands (FAIL) may be expressed as verbs in present tense. Events that are status changes (FAILED) may be expressed as verbs in past tense.

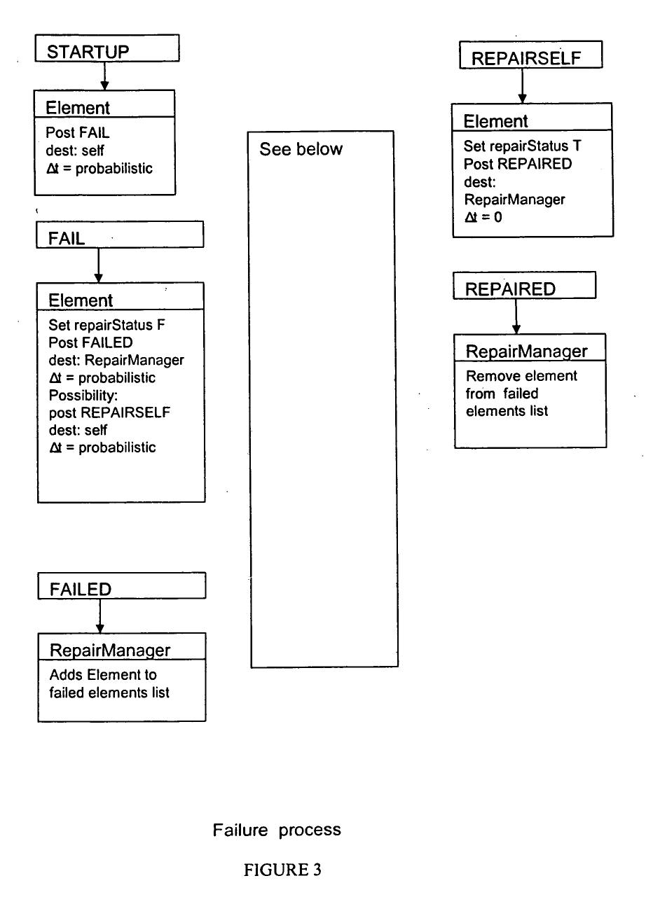

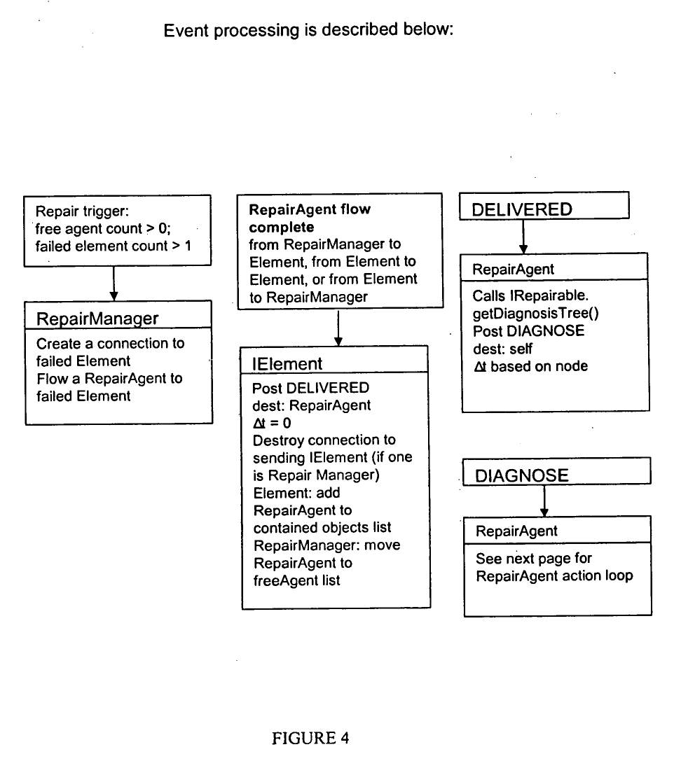

FIG. 3 is another diagram that illustrates the failure process according to the first embodiment. As shown in FIG. 3, when an element fails, it activates a FAIL event which acts on a Repair element. The Repair element then activates a FAILED event which acts on a RepairManager element which add the failed element to a list of failed elements. A REPAIRSELF event acts on the failed element, and if it is successful in repairing the failed element, it activates a REPAIRED event which acts on the RepairManager element by removing the repaired element from the list of failed elements.
FIG. 4 illustrates an exemplary process flow when a Repair Trigger event acts on a RepairManager element to indicate a failed Element, in the first embodiment. The RepairManager creates a connection to the failed Element and flows a RepairAgent element to the failed Element. Once the flow of the RepairAgent to the failed Element is complete, the RepairAgent initiates a Diagnose event which provides input to the RepairAgent element. An exemplary processing loop performed by the RepairAgent is discussed next.
   RepairAgent Action Loop

The following code fragment describes one possible implementation of what the RepairAgent does on receipt of a DIAGNOSE event.

```
if (currentElement repairStatus = = OK)
  if RepairManager.doExhaustive // see note below on the doExhaustive
  flag
    loop over preceeding elements, nearest first
      if Element repairStatus != OK
        flow to preceding IElement
  else
    if originalElement.repairStatus( ) != OK
      flow to original Element
    else
      flow to RepairManager
else
  if exists another node in the current Diagnosis tree
    do next node of currentDiagnosis tree
    post DIAGNOSE to self with Δt = node value
  else
    set fixability flag to F
    flow me to preceding IElement
```

The RepairManager.doExhaustive flag is settable by the modeler and indicates whether a RepairAgent will stop at intermediate Elements when returning from a fixed Element to the original fixed Element

One node of a diagnosis tree can be a command to flow to a 2^{nd}, connected Element, to execute the diagnosis tree there. The RepairAgent returns to the 1^{st} Element, to the same node, if executing the remote 2^{nd} diagnosis tree didn't fix the first Element.

Flow

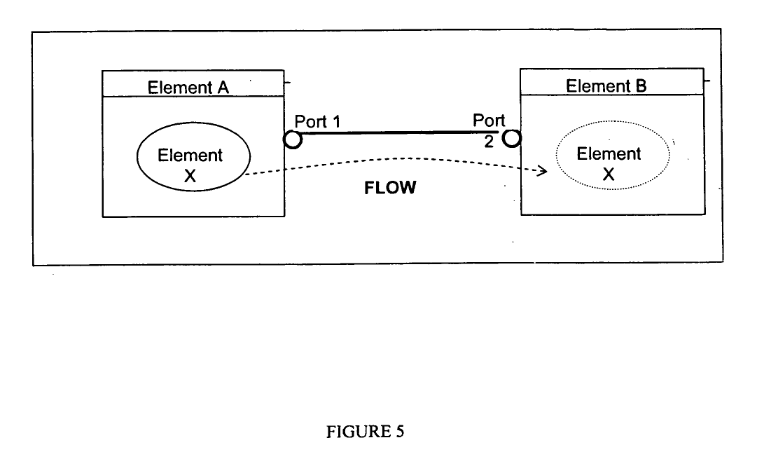

FIG. 5 is a diagram that illustrates the Flow object in the first embodiment. The primitives for modeling are elements and ports. Elements possess ports, which may be connected. Elements may contain (store) elements, which may be flowed through connected ports into other elements as shown in FIG. 5. For example, element X contained (stored) in Element A may be flowed to Element B, via a connection made between Port 1 of Element A and Port 2 of Element B.

To flow an element between two elements, connected by a pair of ports, use is now made of an underlying architecture (for example, the EDS architecture), rather than [pre-flow|flow|post-flow] reconciliation. A list of actions associated with a Flow is shown in the table below followed by code fragments illustrating one implementation of the primitives for implement the Flow object (elements and ports).

| | Element A | Port 1 | Flow X | Port 2 | Element B |
|---|---|---|---|---|---|
| 1 | Send FlowX to | | | | |
| | port | | | | |
| 2 | Update stored | Append outgoing | | | |
| | elements | queue | | | |
| | | Post “FLOW” | | | |
| | | event | | | |
| 3 | | Update outgoing | | Receive “FLOW” | |
| | | queue | | event | |
| | | | | Append incoming | |
| | | | | queue | |
| | | | | Post “ARRIVED” | |
| | | | | event | |
| 4 | | | | Flush incoming | Receive |
| | | | | queue | “ARRIVED” event |
| | | | | | Append stored |
| | | | | | elements |
| | | | | | Post |
| | | | | | “DELIVERED” |
| | | | | | event |
| 5 | | | Receive | | |
| | | | “DELIVERED” event | | |

IPort
   add flowObject(IElement obj)
Port
   [LAMBDA=LONGINT]
   add ‘myLambda’ member variable-latency
   add FLOW_Event_Handler( . . . )
      puts repair agent in port's incoming flow queue
      posts ARRIVED event to container element

flowObject(IElement obj) implementation

```
{
  LAMBDA localLambda = obj.portLambdaOverride( )
  if (localLambda == null)
  {
    localLambda = myLambda
  }
  EMgr.createEvent(“FLOW”, this, otherPort, obj,
localLambda)
}
```

Ielement
   add portLambdaOverride( )
      return LAMBDA|null
Element
   add ARRIVED_Event_Handler( . . . )
      posts DELIVERED event to each flowed element
      performs extraneous processing
   add DELIVERED_Event_Handler( . . . )
      performs extraneous processing
         Attribute Communication

There is a modeling mechanism that allows elements to communicate their attributes. This will utilize the EDS subsystem by defining an extension to the event types.
QUERY_ATTR (source A, target B, params[id, attr_str], Δt)
QUERY_ATTR_RESPONSE (source B, target A, params[id, Attribute], Δt)
QUERY_ATTR_LIST (source A, target B, params[id], Δt)
QUERY_ATTR_LIST_RESPONSE (source B, target A, params[id, AttributeTable], Δt)

This feature represents the realization of two outstanding requirements, namely instantaneous flows (Δt=0) and attribute interrogation (inter-element communication).

Examples such as these, utilizing the actual modeling infrastructure to achieve desirable executable artefacts (network traversal, instantaneous flows, attribute interrogation)—rather than simply leaning on construction medium (programming language) facilities, are important to establish a simulation, rather than merely an animation, of a model.

Repair Agent Mobility

Riding on the back of the flow mechanism (and, in turn, on the EDS architecture), there is an additional requirement for repair agents to be able to navigate/traverse a model independent of the actual network itself.

For example, an electrical network may connect a variety of devices, but the decisions and movement of a repair agent may not necessarily follow ‘the wires’, although they are likely to be guided by knowledge of the patterns of connection in the network.

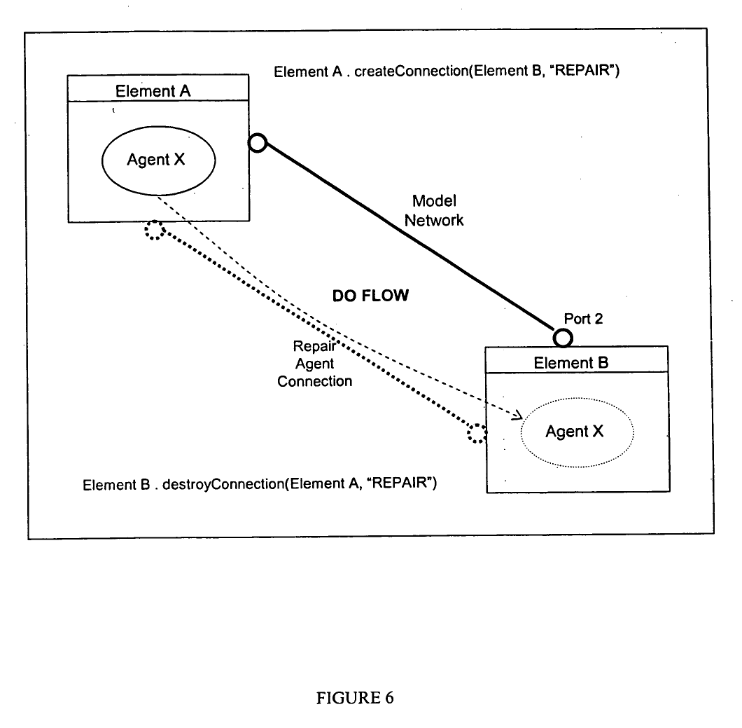

To this end, repair agents are granted the ability to construct transient connections between elements for them to traverse a network. The actual traversal is accomplished via the standard flow mechanism, through these transient connections. Each connection will last at least as long as it takes for the flow to complete, after which it may be discarded. Repair agents will uniquely type these connections by defining their network type to be “REPAIR” as illustrated by the diagram of FIG. 6 (which shows a repair agent connection between Element A and Element B according to the first embodiment) and the following table and code fragments.

| | Element A | Repair Agent | | Element B |
|---|---|---|---|---|
| 1 | | Create connection | | |
| 2 | Create ports & | IPort.flowObject(self) | PERFORM FLOW | Receive Repair Agent |
| | establish connection | | | |
| | Return local port | | | |
| 3 | | On “DELIVERED” | | |
| | | Discard connection | | |
| 4 | Destroy port & | | | Destroy port & |
| | delete connection | | | delete connection |

IPort
   add Iport getRemotePort( )
      Return connected port
   add IElement getRemoteElement( )
      Return element owner of connected port
IElement
   add IPort createConnection(IElement, NetworkType)
      Repair Agent network type=“REPAIR”
      Return local port
   add destroyConnection(IElement, NetworkType)
      Validate IElement exists at other end of connection
      Destroy ports and connection
         Multi-infrastructure interaction capabilities are provided by the use of the following constructs.
         Definition of an Event

An event is defined by the following properties:
Event source: the element that inserted the event into the event queue
Event target: the element directly affected by the event (may be identical to the event source); may be multi-valued
Event identifier: a value identifying the type of event
Latency: When is the event scheduled to occur? Latency may be zero to indicate an event to be fired at the next opportunity
Arguments: any other parameters needed to fully define this event

The simulation method then includes the following processing logic:
1. Calculate next event time for each element; elements that require constant time step modeling simply report their next event time as the next constant time step.
2. Perform earliest event
   a. We will often recalculate the next event for the event target, elements directly affected by the current event and those that listen for this type of event. This is necessary because an event affects the timing of events that would have otherwise occurred after it. For example, if I plan to stop watching TV and go to sleep at 11:00, but the power fails at 9:00, I may decide to go sleep right away at 9:00. We allow “listeners” because an element may not be directly affected by an event but still want to change its schedule. For instance, a power failure does not directly affect my functioning, because I don't run on electricity, but it does affect my scheduling of events.
3. Repeat.
   Definition of a Trigger

Events may also be allowed to be triggered by conditions other than time: A trigger is defined by the following properties
Condition: an expression defining the conditions under which the event is triggered
Action: the action to take when the condition is satisfied

Event conditions may include attribute values, and may include, as a minimum:
attribute value becomes equal to; “:=”
attribute value becomes not equal to; “:≠”
attribute value becomes greater than; “:>”
attribute value becomes less than; “:<”
attribute value becomes greater than or equal to; “:≧”
attribute value becomes less than or equal to; “:≦”
attribute value passes (goes from less than to greater than or vice-versa); “ [symbol] ”
attribute value passes going up (goes from less than to greater than); “↑”
attribute value passes going down (goes from greater than to less than); “↓”
attribute value becomes equal to going up; “:↑=”
attribute value becomes equal to going down; “:↓=”
ANDs and ORs of the conditions

The software of the present system uses a run-time architecture concerned with the management of “Events” and “Triggers”
Events are stored in a chronologically ordered “Event Queue”
   Scheduled according to timing offset (latency-Δt)
   Can spawn (generate) further events
Triggers are stored in an unordered “Trigger Bucket”
   Can spawn further triggers
   Can spawn events
   Can be global, single or multiple in scope
   Declared as being “Constant” or “Transient”
      Constant triggers remain in the bucket after execution unless explicitly removed (eg. a temperature alarm)
      Transient triggers are removed from the bucket after execution (one-shot events, eg. an explosion)
   “Trigger Condition” references one attribute of one element type
      Multiple elements can be linked to one trigger condition
      Multiple conditions can be linked to multiple actions
         eg. Desirable for rescinding events

“Execution Lifespan” (or “Runtime”) is defined as being the length of the event queue as processed from top (earliest) to bottom (latest). This need not be (in fact, is it highly unlikely to be) constant, as both events and triggers can add events to the queue.

A “Scheduler” manages both the event queue and trigger bucket. It is responsible for the processing and management of both events and triggers. Typically, a user specifies at design-time
Triggers
   Exist both inside and outside scenarios
“Scripted” (scenario) Events & their latency
   Exist only inside scenarios

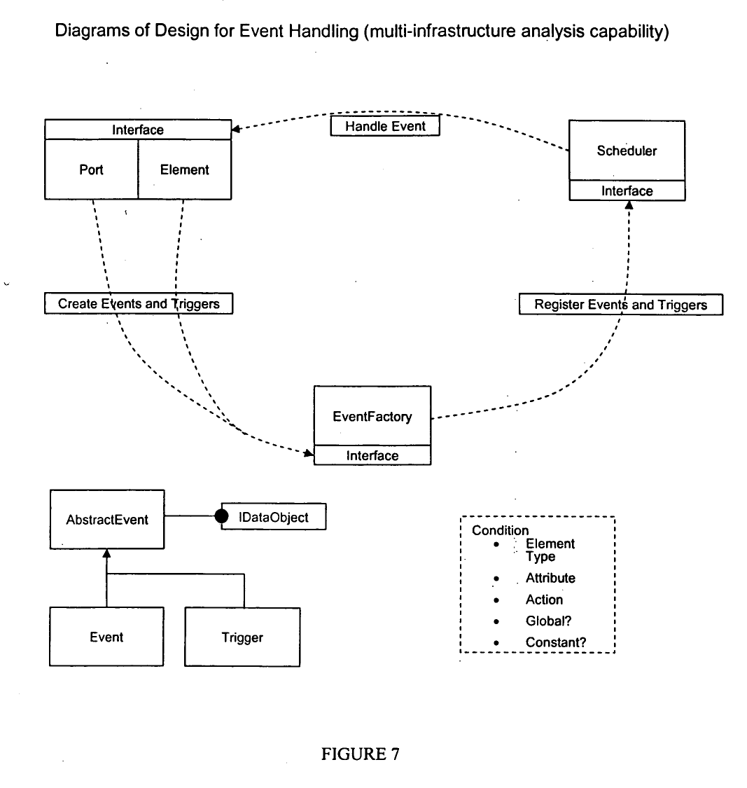

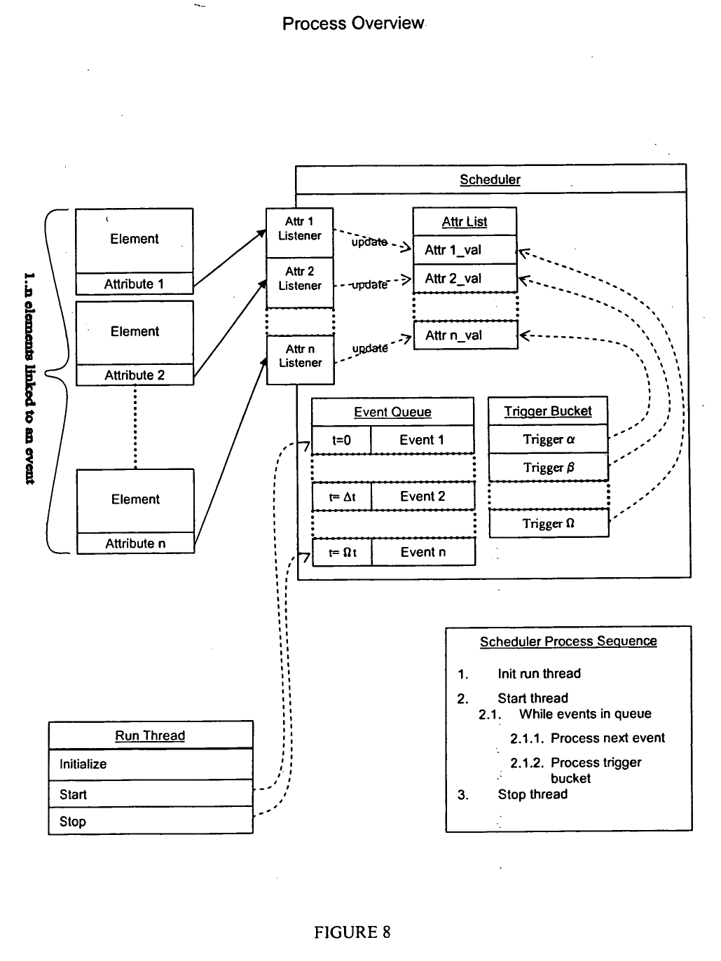

As shown generally in FIGS. 7 and 8, which show event handling and process overview of a risk assessment system of the first embodiment, model execution is driven by the response, by elements, to events. Certain triggers will be able to influence model execution by adding or removing events from the queue.

Relationships

| | | | |
|---|---|---|---|
| Elements | [symbol] | Events | (events notify elements) |
| | → | Triggers | (elements actuate triggers) |

Storage

| | | | |
|---|---|---|---|
| Events | → | Queue | (events stored in queue) |
| Triggers | → | Bucket | (triggers stored in bucket) |

A “Scheduler” component is responsible for the maintenance (registration and updating) of events and triggers, and provide a consistent interface for doing so. Elements, in turn, implement a common interface for this scheduler to use to notify them of events.

To localize the creation and registration of events (with the scheduler), and to remain consistent with the ObjectFactory architecture, the “factory” pattern can be followed to design an “EventFactory” component that can be initialized from a separate library, so that this component can be optionally included with any application built upon the present system, should event processing be required.

The present system's object hierarchy may be restructured to resemble the following, where indented sub-items indicate ‘containment’ and pluralization indicates a ‘one-to-many’ relationship with the parent container:
Workspace
   Models
      Elements
      Scenarios
         Events
         Triggers
         Runs
            Scenario Reference
            Scheduler
            Model
            Seed (PRNG)
         Monte Carlo Sets
            Scenario Reference
            Runs (ΔSeed, Model, Scenario Reference)
            Properties (results monitoring/graphs etc).

Some of the features of the present system include a software based simulation program using time domain probabilistic risk analysis techniques.

Other features include carrying one or more sequences of one or more instructions for execution by one or more processors, the instructions when executed by the one or more processors, cause the one or more processors to perform a time domain probabilistic risk analysis on a network model stored in a computer memory and to perform a multiple step state analysis wherein the state of the previous step is updated based on effects determined from the previous step and the current network information flows; automatically update and record the state of the elements of the network model based on the outcome of each step of the analysis; record and save to a storage medium variables or states of interest; and output to a user readable form variables or states of interest.

Another feature is providing a software based simulation program including detailed repair asset simulation capabilities.

Another feature includes carrying one or more sequences of one or more instructions for execution by one or more processors, the instructions when executed by the one or more processors: provide detailed element level simulation capability of repair assets; allows for the automatic use of detailed repair assets in a time domain probabilistic risk assessment wherein the variability of values used by the repair assets is accounted for automatically; wherein the aforementioned variability of values used by the repair assets can be manipulated by the user as desired; and wherein the repair assets provide for a realistic repair time determination based on known repair quantities and procedures.

Another feature includes a software based simulation program including element to element level interactions between differing but interconnected infrastructure models (for example, between a model of an electrical grid and a model of a water supply system). Interactions from two or more interconnected infrastructure models may be obtained using the software based simulation program.

Another feature provides for carrying out one or more sequences of one or more instructions for execution by one or more processors, the instructions when executed by the one or more processors, cause the one or more processors to perform a time domain probabilistic risk analysis on a network model stored in a computer memory and to: provide network elements that can be assembled into recognizable facsimiles of existing physical and/or non-physical networks; and provide interaction capability between existing physical and/or non-physical networks that are generally considered to belong to different infrastructure sets.

One skilled in the art would recognize that a typical computer system connected to an electronic network could be used to implement the system described herein. It should be appreciated that many other similar configurations are within the abilities of one skilled in the art and it is contemplated that all of these configurations could be used with the methods and systems of the present invention. Furthermore, it should be appreciated that it is within the abilities of one skilled in the art to program and configure a networked computer system to implement the method steps and system of the present invention, discussed earlier herein.

The present invention also contemplates providing computer readable data storage means with program code recorded thereon (i.e., software) for implementing the method steps and system features described earlier herein. Programming the method steps or system features discussed herein using custom and packaged software is within the abilities of those skilled in the art in view of the teachings disclosed herein.

Other embodiments of the invention will be apparent to those skilled in the art from a consideration of the specification and the practice of the invention disclosed herein. It is intended that the specification be considered as exemplary only, with such other embodiments also being considered as a part of the invention in light of the specification and the features of the invention disclosed herein.

What is claimed is:

1. A risk assessment system, comprising:
a plurality of elements each having an attribute for determining if an event causes the respective element to fail;
a repair component configured to repair each of the plurality of elements that has failed;
an event generation component configured to generate an event to effect repair of the plurality of elements that have failed,
wherein the repair component performs a particular repair of each of the failed elements based on the event generated by the event generation component.

2. The risk assessment system according to claim 1, wherein the risk assessment system is implemented as an object-oriented hierarchical data model.

3. The risk assessment system according to claim 2, wherein, when the repair component has repaired at least one of the plurality of elements that has failed, an attribute of the at least one the plurality of elements that has been repaired is changed from a failed state to a repaired state.

4. The risk assessment system according to claim 1, further comprising:
a diagnosis component configured to perform a diagnosis of at least one of the plurality of elements that has failed,
wherein the diagnosis component is activated to provide information to the repair component to assist the repair component in repairing the at least one of the plurality of elements that has failed.

5. The risk assessment system according to claim 4, wherein the diagnosis component includes a diagnosis tree for diagnosing a particular element that has failed, and
wherein the diagnosis tree includes a plurality of diagnosis nodes.

6. The risk assessment system according to claim 4, wherein the diagnosis component includes a plurality of diagnosis trees that are utilized in a predetermined order to diagnose a particular element that has failed, wherein, if a first of the diagnosis trees is not capable of diagnosing the particular element that has failed, a second of the diagnosis trees is utilized to try to diagnose the particular element that has failed, and
wherein each of the diagnosis trees includes a plurality of diagnosis nodes.

7. The risk assessment system according to claim 1, wherein the plurality of elements represent nodes of a network, and wherein the repair component repairs the elements that have failed by constructing transient connections between elements in determining possible corrections to the network in order to repair the elements that have failed.

8. The risk assessment system according to claim 1, wherein an event includes an event source, an event target, an event identifier identifying a type of event, and an event latency identifying when the event is scheduled to occur.

9. The risk assessment system according to claim 8, wherein an event occurs when a trigger for the event has occurred.

10. The risk assessment system according to claim 9, wherein the trigger includes a condition under which the trigger will cause the event to occur, and an action that results when the condition is satisfied.

11. A risk assessment method for performing risk assessment on a system, the method comprising:
assigning an attribute to a plurality of elements, for determining if an event causes the respective element to fail;
determining whether or not the event has occurred in the system, and which of the plurality of elements has failed;
repairing, by a repair component, each of the plurality of elements that has failed,
wherein the repairing step includes:
generating a particular event to effect repair of the plurality of elements that have failed.

12. The method according to claim 11, further comprising:
modeling the system as an object-oriented hierarchical data model.

13. The method according to claim 12, wherein, when the repairing step has repaired at least one of the plurality of elements that has failed, an attribute of the at least one the plurality of elements that has been repaired is changed from a failed state to a repaired state.

14. The method according to claim 11, further comprising:
performing a diagnosis of at least one of the plurality of elements that has failed,
wherein the performing a diagnosis step is activated to provide information to the repairing step to assist in repairing the at least one of the plurality of elements that has failed.

15. The method according to claim 14, wherein the performing a diagnosis step includes:
utilizing a diagnosis,
wherein the diagnosis tree includes a plurality of diagnosis nodes for diagnosing a particular element that has failed.

16. The method according to claim 14, wherein the performing a diagnosis step includes:
utilizing a plurality of diagnosis trees in a predetermined order to diagnose a particular element that has failed, wherein, if a first of the diagnosis trees is not capable of diagnosing the particular element that has failed, a second of the diagnosis trees is utilized to try to diagnose the particular element that has failed, and
wherein each of the diagnosis trees includes a plurality of diagnosis nodes.

17. The method according to claim 11, wherein the plurality of elements represent nodes of an electrical network, and wherein the repairing step comprises:
constructing transient connections between elements in determining possible corrections to the network in order to repair the elements that have failed.

18. The method according to claim 11, wherein an event includes an event source, an event target, an event identifier identifying a type of event, and an event latency identifying when the event is scheduled to occur.

19. The method according to claim 18, wherein an event occurs when a trigger for the event has occurred.

20. The method according to claim 1, wherein the trigger includes a condition under which the trigger will cause the event to occur, and an action that results when the condition is satisfied.

21. A computer program product executable on a general purpose computer, the computer program product being stored in a computer readable medium, and, when executed on the general purpose computer, causing the general purpose computer to perform the steps of:
assigning an attribute to a plurality of elements, for determining if an event causes the respective element to fail;
determining whether or not the event has occurred in the system, and which of the plurality of elements has failed;
repairing, by a repair component, each of the plurality of elements that has failed,
wherein the repairing step includes:
generating a particular event to effect repair of the plurality of elements that have failed.

22. The computer program product according to claim 21, further comprising:
modeling the system as an object-oriented hierarchical data model.

23. The computer program product according to claim 22, wherein, when the repairing step has repaired at least one of the plurality of elements that has failed, an attribute of the at least one the plurality of elements that has been repaired is changed from a failed state to a repaired state.

24. The computer program product according to claim 21, further comprising:
performing a diagnosis of at least one of the plurality of elements that has failed,
wherein the performing a diagnosis step is activated to provide information to the repairing step to assist in repairing the at least one of the plurality of elements that has failed.

25. The computer program product according to claim 24, wherein the performing a diagnosis step includes:
utilizing a diagnosis tree for diagnosing a particular element that has failed,
wherein the diagnosis tree includes a plurality of diagnosis nodes.

26. The computer program product according to claim 24, wherein the performing a diagnosis step includes:
utilizing a plurality of diagnosis trees in a predetermined order to diagnose a particular element that has failed, wherein, if a first of the diagnosis trees is not capable of diagnosing the particular element that has failed, a second of the diagnosis trees is utilized to try to diagnose the particular element that has failed, and
wherein each of the diagnosis trees includes a plurality of diagnosis nodes.

27. The computer program product according to claim 21, wherein the plurality of elements represent nodes of a network, and wherein the repairing step comprises:
constructing transient connections between elements in determining possible corrections to the network in order to repair the elements that have failed.

28. The computer program product according to claim 21, wherein an event includes an event source, an event target, an event identifier identifying a type of event, and an event latency identifying when the event is scheduled to occur.

29. The computer program product according to claim 28, wherein an event occurs when a trigger for the event has occurred.

30. The computer program product according to claim 21, wherein the trigger includes a condition under which the trigger will cause the event to occur, and an action that results when the condition is satisfied.

31. A software based simulation program, comprising:
performing element to element level interactions between a first infrastructure model and a second infrastructure model,
wherein the first and second infrastructure models are interconnected, and
wherein each of the first and second infrastructure models is represented by objects having attributes.

32. The software-based simulation program according to claim 31, further comprising:
determining whether an event has occurred, and if so, which of the objects are affected by the event,
wherein an object of the first infrastructure model that is affected by the event causes a posting of another event to another object of the second infrastructure model.
